(19) United States
(12) Patent Application Publication
(10) Pub. No.: US 2025/0013136 A1
(43) Pub. Date: Jan. 9, 2025

(54) PROJECTOR OR DISPLAY COMPRISING A SCANNING LIGHT SOURCE AND A PIXELATED ARRAY

(71) Applicant: Carl Zeiss Jena GmbH, Jena (DE)

(72) Inventors: Adrian Grewe, Jena (DE); Marc Junghans, Jena (DE); Roman Kleindienst, Jena (DE); Siemen Kuehl, Jena (DE); Christoph Erler, Jena (DE)

(21) Appl. No.: 18/712,670

(22) PCT Filed: Nov. 23, 2022
(86) PCT No.: PCT/EP2022/082945

§ 371 Date: Jul. 15, 2024

(30) Foreign Application Priority Data
Nov. 23, 2021 (DE) 10 2021 130 561.6

(51) Int. Cl. G03B 21/14; G02B 27/48; G03B 21/20

(52) U.S. Cl. CPC G03B 21/147; G02B 27/48; G03B 21/2013; G03B 21/2033; G03B 21/2066; G03B 21/208

(57) ABSTRACT

The invention preferably relates to an image-generating unit with a light source for generating illumination radiation and a light-modulating pixel array for generating an image by pixel-wise modulation of the illumination radiation incident on the pixel array. The image-generating unit is characterized in that the illumination radiation, upon incidence on the light-modulating pixel array, has a lateral extent which is smaller than the pixel array and is guided over the pixel array by means of a scanning unit for generating an image. By a combination of the process of scanning the illumination radiation over the light-modulating pixel array, the speckle signatures of the scanning unit and of the pixel array are superimposed or combined to generate an image point. Advantageously, visible speckle patterns in the resulting image can thus be significantly reduced.

The invention preferably relates to an image-generating unit with a light source for generating illumination radiation and a light-modulating pixel array for generating an image by pixel-wise modulation of the illumination radiation incident on the pixel array. The image-generating unit is characterized in that the illumination radiation, upon incidence on the light-modulating pixel array, has a lateral extent which is smaller than the pixel array and is guided over the pixel array by means of a scanning unit for generating an image. By a combination of the process of scanning the illumination radiation over the light-modulating pixel array, the speckle signatures of the scanning unit and of the pixel array are superimposed or combined to generate an image point. Advantageously, visible speckle patterns in the resulting image can thus be significantly reduced.

### Background and Prior Art

The invention relates to the field of illuminated systems. In particular, the present invention relates to the reduction of speckle and interference patterns in displays or projectors which are illuminated by means of coherent light sources, in particular lasers.

The use of lasers as an alternative to white light sources, such as xenon arc lamps, leads to a number of advantages in imaging. In particular, lasers allow for higher color saturation, higher performance, improved efficiency and contrast.

Lasers have also established themselves as an advantageous illumination source for applications involving head-up displays (HUDs). HUDs are used to represent information in a virtual plane, for example in front of the windshield of a motor vehicle. A vehicle occupant or a driver of the vehicle can read the information without having to look down at the dashboard.

If coherent light sources, such as lasers, are used in projectors or displays, undesirable interference phenomena, so-called speckle, may occur. Speckle patterns are in particular the grainy interference phenomena that can be observed with sufficiently coherent illumination of optically rough object surfaces.

When laser light is incident on a rough surface—for example when incident on a projection screen—it is reflected at various angles, and the coherent laser light randomly spatially interferes with itself. The resulting interference of the coherent light radiation causes constructive and destructive interference. For the human eye, this image defect occurs in the form of visible grains or a speckle pattern.

The unevennesses of the illuminated rough surfaces can also be regarded as scattering centers from which spherical waves of different phases originate, which interfere in the far field. A spatial structure with randomly distributed intensity minima and maxima is generated. As three-dimensional interference phenomena, there are longitudinal and transverse speckles, which depend on the respective longitudinal and transverse coherence. Transverse speckles have a higher significance at a greater distance, since the individual spherical wave components can be simplified as planar waves.

The speckles are therefore caused by local phase differences within the aperture of the optical system, which are inevitably caused by the surface roughness of individual surfaces in the optical system or by the roughness of the projection screen. A speckle pattern is therefore spatially fixed and characteristic of an optical path through the system.

In the prior art, there are a number of approaches to reduce the adverse effect of speckle patterns on image quality.

In U.S. Pat. No. 5,272,473, an image-generating system with a coherent light source is proposed, in which a display screen is coupled to a transducer for generating acoustic surface waves to reduce the occurrence of speckles. However, the implementation is complex and in addition cannot be transferred to any desired displays or projection arrangements.

U.S. Pat. No. 8,262,235 B2 discloses a laser projector which comprises an oscillation apparatus in which at least one optical element of the optical projection system is periodically oscillated along the optical axis of the light. The oscillating element in the laser projector is intended to reduce the speckle pattern on the screen to such an extent that it can no longer be seen by the naked eye. However, the oscillating change along the optical axis may decrease image quality.

U.S. Pat. No. 9,541,760 B2 discloses a head-up display for a vehicle, wherein the head-up display comprises a laser and a scanning system, with which an image to be represented in a field of view of a driver of the vehicle is generated point-by-point from individual points. In order to avoid unwanted differences in brightness, the laser is selected in such a way that the laser points on the projection surface are so small that they are still smaller than the resolution of the human eye after the magnification of the image to be represented in the virtual image plane.

From U.S. Pat. Nos. 4,035,068 and 5,313,479 it is known to use movable diffusers for the reduction of speckle in order to average speckle patterns over the integration time of the observer/detector using local phase modulation and to reduce the visibility thereof.

For reducing the speckle patterns observable in an image, WO 97/02507 proposes the rotation of a speckle field which lies between the object point and an image point in a laser projector about an optical axis in order to average over a plurality of uncorrelated fields.

US 2008/0304128 A1 relates to a laser projection system in which an expanded laser beam is directed to a two-dimensional light modulator, for example an LCD panel, which modulates the expanded laser beam pixel-by-pixel for generating an image on a projection surface. In order to reduce the visibility of speckle in the projected image, angle-dependent scanning is imprinted on the expanded laser beam. For this purpose, a movable mirror is provided, the surface of which is imaged onto the input of a multi-mode waveguide such that the laser beam at the input of the waveguide has different angles, which, after its expansion onto the LCD panel and projection onto the projection screen, leads to averaging of speckle patterns.

EP3267236 A1 discloses a projector comprising an image processing unit and an optical scanner, in which a laser beam is guided in two directions over a surface to be scanned by means of a MEMS mirror. On the surface to be scanned, one or more photodetectors are present, which are configured to measure the incident laser radiation in a detection region. The measurement signal of the photodetector(s) is transmitted to a control unit and can be used to adapt and/or control the light source or the MEMS mirror. This is to make it possible to compensate for any variation in the scan amplitude of the MEMS mirror, for example due to temperature fluctuations.

The surface to be scanned is a light-transmissive element, preferably glass. An image which is drawn onto the surface to be scanned is preferably projected onto a projection screen behind it. The image is preferably generated based on the image data of the image processing unit by modulating the driver of the light source. For a reduction of speckle patterns, the surface to be scanned is designed in a preferred embodiment as an array of microlenses, with the result that interference between light fields of different microlenses- and thus the occurrence of speckle—is avoided.

There is a need for improvement with regard to the prior art approaches. In particular, the approaches to reducing the speckle patterns can simultaneously lead to a decrease in image quality or are complex in terms of implementation. It would therefore be desirable to provide an apparatus which allows effective speckle reduction by simple means without affecting the image quality.

### OBJECT OF THE INVENTION

The object of the invention is to provide an image-generating unit without the disadvantages of the prior art. In particular, it was an object of the invention to provide an image-generating unit which enables an effective reduction of speckle patterns with simple, constructive means and at the same time ensures excellent image quality.

### SUMMARY OF THE INVENTION

The object is achieved by the features of the independent claims. Advantageous configurations of the invention are described in the dependent claims.

In a preferred embodiment, the invention relates to an image-generating unit having a light source for generating illumination radiation and a light-modulating pixel array for generating an image by pixel-wise modulation of the illumination radiation incident on the pixel array, wherein the illumination radiation, upon incidence on the light-modulating pixel array, has a lateral extent which is smaller than the pixel array and is guided over the pixel array by means of a scanning unit for generating an image in order to reduce the visibility of speckle patterns in the generated image.

This advantageously utilizes the fact that during the generation of an image point, speckle patterns which result from the scanning unit and the light-modulating pixel array are superimposed and thus represent higher-frequency speckle patterns which are preferably no longer visible in the generated image.

The image unit according to the invention enables the perceptible speckle patterns to be reduced in a display or projection plane advantageously with simple means, without a decrease in image quality.

According to the invention, this utilizes the fact that both a scanning unit and a light-modulating pixel array have characteristic speckle signatures for different scan positions or pixel states. In particular, each pixel of a light-modulating pixel array will have a specific speckle signature, which depends on the surface condition and/or the controlled state (for example, a crystal alignment in the case of an LCD (liquid crystal display)). Similarly, speckles generated by a scanning unit will also differ for different scan positions. In the case of a mirror-based scanning unit, the speckle patterns generated will depend not only on the position of the laser beam on the mirror surface but also on the different angular light emission, meaning that a speckle pattern in the light beam varies with the scan position.

By a combination of a process of scanning a light beam over a pixel array, the speckle signatures of the scanning unit and of the pixel array are superimposed or combined to generate an image point. FIGS. 2a)-d) illustrates this by way of example. While an illumination beam guided by the scanning unit sweeps over a pixel of the light-modulating pixel array, speckle patterns which result from the scanning unit and differ depending on the scan positions are superimposed with a speckle pattern that is characteristic of the respective pixel.

A resulting image point is advantageously characterized by an averaged speckle pattern which has a higher spatial frequency and is not perceptible to a viewer or is perceptible only to a reduced extent.

A reduction in the visibility of speckle patterns in the generated image is therefore preferably achieved by virtue of the fact that, as it sweeps over the pixels of the light-modulating pixel array, the illumination radiation is guided by the scanning unit in such a way that speckle patterns which result from the scanning unit and differ depending on the scan position are superimposed with a speckle pattern that is characteristic of the respective pixel.

The image-generating unit according to the invention thus advantageously utilizes inherent variations of the components in order thereby to generate an image of high quality without bothersome brightness patterns or interference patterns. The light source itself can have a high coherence—as is desirable for holographic applications, for example—without bothersome interference patterns (speckles) being perceptible. In order to generate an already substantial reduction in the perceptible speckle patterns, it is not necessary to reduce the coherence of the light beam nor to further redirect, (de) focus or rotate the illumination beam or to guide it through a microlens array. Instead, the speckles are reduced by the image—generating scanning process on a pixel array—as described above-itself, without a decrease in image quality.

In this respect, the invention represents a departure from known approaches in technology. In the case of the use of light-modulating pixel arrays, it is customary in the prior art to illuminate them by means of expanded illumination beams which are as homogeneous as possible. The image is generated by a pixel-wise modulation of the expanded illumination beam, which illuminates the entire pixel array as homogeneously as possible.

According to the invention, it is instead preferable that the illumination radiation, upon incidence on the light-modulating pixel array, has a lateral extent which is smaller than the pixel array. Preferably, the illumination radiation, upon incidence on the pixel array, for example, can have a lateral extent which is smaller than the lateral extent of the pixel array by a factor of 5, 10, 100 or more. This ensures that a multiplicity of speckle patterns are generated (and superimposed) in the process of scanning the illumination radiation over an individual pixel in order to generate an image point. For the illumination radiation, it is therefore preferred that it is guided in a focused manner in the form of a beam onto the pixel array. The terms illumination radiation, illumination beam or beam are preferably used synonymously. Optical components such as lenses can collimate or focus the illumination radiation accordingly.

The speckle reduction can be achieved advantageously for a wide range of light sources.

In a preferred embodiment, the illumination radiation is coherent radiation and/or the light source is a laser. Coherence preferably refers to the property of optical waves according to which there is a fixed phase relationship between two wave trains. As a result of the fixed phase relationship between the two wave trains, spatially stable interference patterns can arise. For holographic applications, coherent illumination radiation is desirable, since only in this way is a reconstruction of the intensity and phase of the wave field possible. The disadvantage of coherent irradiation is the occurrence of unwanted interference patterns or speckle patterns. Coherence can preferably also be understood as interference capability.

In terms of coherence, a distinction can be made between temporal and spatial coherence. Spatial coherence preferably represents a measure for a fixed phase relationship between wave trains perpendicular to the propagation and is given, for example, for parallel light beams. Temporal coherence preferably represents a fixed phase relationship between wave trains along the direction of propagation and is given in particular for narrowband, preferably monochromatic light beams.

The coherence length preferably denotes a maximum path length difference or time-of-flight difference that two light beams from a starting point have, so that a (spatially and temporally) stable interference pattern arises during their superposition. The coherence time preferably refers to the time that the light needs to travel a coherence length.

Lasers can have coherence lengths in the micrometer range, the meter range up to the kilometer range. Typical ranges for the use of lasers as light sources in image-generating units are, for example, between 1 m-100 m, which, on the one hand, makes the lasers excellently suited for holographic imaging and, on the other hand, can lead to unwanted (laser) speckle patterns.

In a particularly preferred embodiment, the light source is therefore a laser. It is particularly preferably a narrow-band, preferably monochromatic laser with a preferred wavelength in the visible range (preferably 400 nm to 780 nm).

For the purposes of the invention, lasers preferably designate light sources which emit laser radiation; non-exhaustive examples include solid-state lasers, preferably semiconductor lasers or laser diodes, gas lasers or dye lasers.

Other light sources, preferably coherent light sources, may also be used by preference. Preferred are narrow-band light sources, preferably monochromatic light sources, including, for example, light-emitting diodes (LEDs), optionally in combination with monochromators. Compared to lasers, LEDs in most cases have lower coherence lengths in the range of millimeters or micrometers.

In a preferred embodiment, the image-generating unit comprises two or more light sources, preferably two or more monochromatic lasers, and/or a polychromatic light source having illumination radiation in two or more wavelength ranges. The illumination radiation emitted by the two or more light sources is preferably guided over the light-modulating pixel array along a common optical axis and by means of the same scanning unit. However, it is also possible that two or more light sources are guided via separate scanning units.

For color imaging, it may be preferred, for example, to provide illumination radiation in the red wavelength range (preferably 630 nm-700 nm), in the green wavelength range (preferably 500 nm-560 nm) and in the blue wavelength range (preferably 450 nm-475 nm).

Particularly preferably, a laser system with three monochromatic lasers or a polychromatic laser with a laser emission in each the red, green or blue (RGB) range is provided for this purpose.

For controlling components of the image-generating unit, such as the light-modulating pixel array and/or the scanning unit, the image-generating unit preferably comprises a control unit.

The control unit is preferably suitable for this purpose to output electrical control signals to and/or to receive them from the components. Without limitation, the control unit may comprise, for example, a microprocessor, a microcomputer, an integrated circuit (IC), an ASIC (application-specific integrated circuit), a programmable logic circuit (PLD), a field programmable gate array (FPGA), a programmable logic controller and/or other electronic circuit elements, such as digital-to-analog converters, analog-to-digital converters, memories and/or (signal) amplifiers.

A person skilled in the art recognizes that preferred method steps, which are disclosed in connection with the image-generating unit for generating an image, can preferably be carried out by the control unit. Preferably, corresponding software and/or firmware can be installed for this purpose on the control unit or an external data processing unit connected to the control unit.

The illumination radiation or the light beam is guided over the pixel array preferably by means of the scanning unit.

Preferably, the scanning unit (or a control unit connected thereto) is configured to guide the illumination radiation line by line or column by column over the entire pixel array. The scanning frequency of the scanning unit preferably refers to the frequency at which the scanning unit scans the entire pixel array or the frequency at which the illumination radiation sweeps over one and the same pixel. A scanning frequency of 25 Hz therefore preferably means that the scanning unit scans the entire pixel array 25 times per second or, when preferably scanning line by line or column by column, sweeps over a specific pixel 25 times per second.

In preferred embodiments, the scanning frequency is greater than 20 Hz, preferably more than 25 Hz, 30 Hz, 40 Hz, 50 Hz, 60 Hz or more.

The scanning unit can be any of a variety of systems.

In a preferred embodiment, the scanning unit comprises one or more scanning mirrors, which are preferably tiltable about one or more axes. For example, the scanning unit may comprise a first scanning mirror, wherein the first scanning mirror is tiltable about a first axis in order to guide the illumination radiation on the pixel in a first direction (e.g. horizontal), and a second scanning mirror which is tiltable about a second axis in order to guide the illumination radiation on the pixel in a second direction (e.g. vertical). Preferably, the scanning mirror may be a galvanometer mirror (for example, with gimbal suspension) or a microelectromechanical mirror (MEMS). The scanning unit can use an individual scanning mirror (tilted in at least two axes) or a combination of two or more scanning mirrors.

In a further embodiment, the scanning unit comprises one or more lenses and/or a lens array, by means of which a movement of the illumination beam on the pixel array is controllable. For this purpose, at least one of the lenses may be present in a translational and/or rotatable design. Likewise, the scanning unit may have prisms and/or wedges as beam-diverting elements.

In a further embodiment, the scanning unit comprises one or more diffractive optical elements, by means of which a movement of the illumination radiation on the pixel array is controllable. An example of a scanning unit comprising diffractive optical elements, which are formed as two decentered diffractive Fresnel lenses with opposing optical powers, is described in Bawart et al. (Bawart et al., Dynamic beam-steering by a pair of rotating diffractive elements, Optics Communications 460 (2020) 125071).

Other scanning systems are also conceivable. For example, the use of an acousto-optical deflector (AOD) may be preferred. The different techniques can also be combined, of course.

Preferably, the light-modulating pixel array (or a control unit connected thereto) is configured to modulate pixel-by-pixel illumination radiation which is incident on the pixel array. The modulation is preferably an intensity modulation and/or phase modulation of the illumination radiation. The modulation is carried out pixel-by-pixel in such a way that preferably each pixel of the light-modulating pixel array is controllable in order to set a modulation state, i.e. a defined intensity modulation and/or phase modulation for the region of the pixel. The pixel array is preferably a two-dimensional, planar light modulator.

In preferred embodiments, the pixel array has a multiplicity of pixels, preferably 100, 200, 500, 1000, 5000, 10,000, 50,000, 100,000, 500,000, 1,000,000 or more pixels.

Preferably, the pixels are arranged in a plane or surface which is preferably perpendicular to the optical axis along which the illumination radiation substantially propagates.

Terms such as substantially, approximately, about, circa, etc. preferably describe a tolerance range of less than +20%, preferably less than +10%, particularly preferably less than +5%, and in particular less than +1% and always include the exact value. Preferably, ‘similar’ describes sizes that are approximately the same. ‘Partially’ preferably describes at least 5%, particularly preferably at least 10%, and in particular at least 20% or at least 40%.

The multiplicity of pixels are arranged in the pixel array preferably in the form of a matrix, a line-by-line or column-by-column arrangement of the pixels can be particularly preferred, which leads, for example, to a rectangular pixel array with a horizontal and vertical extent. Likewise, other arrangements of the pixels in the pixel array, for example on concentric circles, are also conceivable.

The pixels may preferably have a rectangular, square or diamond shape, but other two-dimensional or three-dimensional shapes are also conceivable, e.g. circular, oval, triangular, polygonal, etc.

The array frequency of the pixel array preferably denotes the frequency at which the pixel array can change the states of all pixels of the pixel array for generating an image or the frequency at which a state of an individual pixel of the pixel array can be changed for generating the image. The states of the pixels of a pixel array can preferably be changed simultaneously. It may also be preferred to change the states of the pixels of a line and/or column of the pixel array simultaneously or to change the states of the individual pixels successively. While in the first case the array frequency corresponds to the frequency at which the state of all pixels is simultaneously controlled, in the latter two cases it corresponds to the frequency at which the states of pixels of the same line/column are changed or to the frequency at which the state of an individual pixel is changed for generating the image.

In preferred embodiments, the array frequency is greater than 20 Hz, preferably greater than 25 Hz, 30 Hz, 40 Hz, 50 Hz, 60 Hz or more.

For the purposes of the invention, the refresh rate preferably refers to the frequency at which one image per second can be generated by means of the image-generating unit.

The refresh rate preferably corresponds to the minimum of scanning frequency and array frequency. The scanning frequency is preferably equal to or an (integer) multiple of the array frequency, and/or the array frequency is preferably equal to or an (integer) multiple of the scanning frequency.

The generation of an image by means of the image-generating unit is to be explained below by way of a non-limiting example in which the scanning frequency is equal to the array frequency.

For example, for the generation of an image, provision may be made for the state of all pixels of the pixel array to be changed simultaneously at an array frequency of 30 Hz. The scanning unit likewise guides the illumination radiation over all the pixels of the pixel array at a scanning frequency of 30 Hz. This means that the scanning unit scans the entire pixel array at a frequency of 30 Hz or the illumination radiation accordingly sweeps over one and the same pixel at a frequency of 30 Hz. The state of the respective pixels over which the illumination radiation sweeps at a frequency of 30 Hz likewise changes at an array frequency of 30 Hz. Thus an image point of the image to be generated is generated or defined at a refresh rate of 30 Hz. The image point is preferably generated during a scanning process for a period of time while the illumination radiation irradiates a corresponding pixel of the pixel array or sweeps over it. With each new scanning process, a changed image point can be generated or defined depending on any change in state of the pixels on the pixel array. If the refresh rate is high enough, as in the present case, the limited integration time of the eye leads to the successively generated image points being perceived as continuous images.

Such image generation by combination of a scanning unit and a pixel array represents a departure from known approaches of the prior art, in which, for example, a light-modulating pixel array is irradiated with expanded substantially homogeneous illumination radiation. In those cases, the refresh rate is specified by the array frequency of the pixel array. If the pixels of a pixel array experience a change in state at a frequency of 30 Hz, a corresponding image is likewise generated at 30 Hz. In the case of expanded substantially homogeneous illumination radiation, each pixel is permanently irradiated.

The introduction according to the invention of an additional scanning unit with which the respective pixels are not permanently irradiated, but in which the illumination radiation is guided over the pixel array in repeating scanning processes, is not obvious to a person skilled in the art but appears to be superficially redundant.

As explained in the introductory part, however, it was recognized according to the invention that by performing a process of scanning over the pixel array for generating an image point, the speckle signatures of the scanning unit and of the pixel array are superimposed or combined. While an illumination beam guided by the scanning unit sweeps over a pixel of the light-modulating pixel array, speckle patterns which result from the scanning unit and differ depending on the scan position are superimposed with a speckle pattern characteristic of the respective pixel. A resulting image point is advantageously characterized by an averaged speckle pattern which has a higher spatial frequency and is not perceptible to a viewer or is perceptible only to a reduced extent. According to the invention, different light-modulating pixel arrays can be used.

In a preferred embodiment, the light-modulating pixel array is a liquid crystal display (LCD) and/or a mirror matrix, preferably a micromirror array, for example a digital micromirror device (DMD). Other spatial light modulators (SLMs) can also be used.

In the prior art, a large number of liquid crystal displays which can be used for the invention are known.

In general, liquid crystal displays are based on the fact that liquid crystals can influence the polarization direction of light depending on an applied voltage. By pixel-wise modulation of the crystal orientation, polarized illumination radiation can thus be transmitted or absorbed pixel-by-pixel in order to generate an image. For example, the polarized light can be rotated by 90 degrees in one state of the liquid crystal and not rotated in another state. In order to create an LCD with an absorbent state or a transmissive state, a polarizer may be provided on each side of the liquid crystal such that the polarization angles of the polarizers are offset by 90 degrees.

For example, a liquid crystal display may comprise a transparent electrode mounted on the inner sides of two substrates in different display modes, e.g. in a twist nematic (TN) display mode, in which liquid crystal molecules with positive (+) dielectric isotropy are arranged parallel to the substrates and twisted with an angular difference of almost 90 degrees between the substrates, or a super twist nematic (STN) display mode, in which the liquid crystal molecules are arranged similar to a TN display mode but are twisted with an angular difference of 180 to 270 degrees between the substrates. Other display types such as triple super-twisted nematic etc. are also conceivable. According to the invention, a multiplicity of different liquid crystal displays can be used.

A micromirror array is preferably a microelectromechanical system (MEMS) comprising a multiplicity of micromirrors for the dynamic modulation of light. In a (tilt) mirror matrix or a micromirror array, preferably a DMD, the pixels are formed by the individual (micro) mirrors, which can preferably assume discrete deflections. The individual micromirrors of the (tilt) mirror matrix can preferably be electrostatically actuated and in particular switch between at least two (tilt) states, wherein preferably one state causes a diversion of the illumination radiation to an image point on the image to be generated and another state causes a diversion of the illumination radiation to outside the image to be generated, for example, to an absorber.

DMDs can have different constructions. For example, the mirrors may be connected to a yoke located underneath, wherein the yoke in turn is connected, via two thin, mechanically compliant torsion hinges, to support posts which are attached to the substrate underneath. Electrostatic fields generated between a memory cell located underneath (e.g. SRAM), the yoke and the mirror can cause a positive or negative tilt direction.

Advantageously, the inherent variation of the speckle signatures of the scanning units and pixel arrays specified as preferred leads to a significant reduction of speckle. One preferred parameter for reducing speckle depending on the application is also the lateral extent of the illumination beam on the pixel array.

In a preferred embodiment, the illumination radiation, upon incidence on the pixel array, has a (maximum) lateral extent which is smaller than a (minimum) lateral extent of the pixel array by a factor of 5, 10, 100 or more.

In a preferred embodiment, the illumination radiation, upon incidence on the pixel array, has a (maximum) lateral extent of less than 50, 30, 20, 10, 5, 4, 3, 2 or less than 1 pixel. It may also be preferred that the maximum lateral extent of the illumination radiation, upon incidence on the pixel array, is, for example, only 0.8; 0.5; 0.2 or less the size of one pixel. It may likewise also be preferred that the maximum lateral extent of the illumination radiation, upon incidence on the pixel array, is more than 1 pixel or more than 2, 3, 4, 5, 10 or more pixels.

In preferred embodiments, the maximum lateral extent of the illumination radiation, upon incidence on the pixel array, may have a size which is between 0.2 times and 50 times the size of a single pixel.

For the illumination radiation, it is preferred that it is guided in a focused manner in the form of a beam onto the pixel array. The lateral extent of the illumination radiation, upon incidence on the pixel array, is preferably given by the full width at half maximum (FWHM) of the light intensity. The lateral extent of the illumination radiation, upon incidence on the pixel array, thus preferably corresponds to the spot size (FHMW) of the illumination radiation on the pixel array.

The lateral extent of the pixel array preferably denotes a minimum extent along the plane of the planar pixel array (measured by the centroid of area). In the case of a square pixel array, the minimum lateral extent preferably corresponds to a length of the square. In the case of a rectangular shape of the pixel array, the minimum lateral extent preferably corresponds to the smaller of the two lengths of the rectangle. For a circular pixel array, the lateral extent is preferably given by the diameter.

The abovementioned preferred sizes show particularly good results with regard to a reduction of speckle patterns in the generated pattern. On the one hand, the size of the incident illumination radiation is sufficiently small to ensure that for the generation of an image point (corresponding to a pixel of the pixel array) a multiplicity of speckle signatures (resulting from different scan positions of the scanning system) are superimposed with the speckle signature of a respective pixel. On the other hand, the size of the incident illumination radiation is not so small that the speckle signatures of the scanning system and pixel array are not effectively averaged.

A person skilled in the art knows to ensure a desired beam profile when the illumination radiation is incident on the pixel array by the use of optical components.

In a preferred embodiment, one or more lenses and/or a lens array is present in the beam path in front of the pixel array, by means of which the lateral extent of the illumination radiation, upon incidence on the pixel array, is set, preferably by means of which a smaller spot size of the illumination radiation on the pixel array can be ensured.

In a preferred embodiment, one or more lenses are present in the beam path between the scanning unit and the pixel array, by means of which it is ensured that the illumination radiation is guided onto the pixel array independently of the point of incidence on the pixel array at a constant angle of incidence. The one or more lenses may preferably be a diffractive, a refractive or a Fresnel lens. In a preferred embodiment, the one or more lenses can be positioned such that the scanning unit is located in the object-side focal point of the lens (see FIG. 11). The distance between the scanning unit and the one or more lenses can also be varied to set a desired radiation pattern.

The inherent variation of the speckle signatures of commercially available scanning units and pixel arrays already advantageously leads to a significant decrease in perceptible speckle structures or patterns in the generated image. For the purposes of the invention, the term speckle signature preferably characterizes the property of the components of the image-generating unit to generate characteristic speckle patterns in the generated image. As explained in the introductory part, speckle patterns are in particular the grainy interference phenomena that can be observed with sufficiently coherent illumination of optically rough object surfaces. In order to generate an image point, a multiplicity of speckle signatures of the scanning system (resulting from different scan positions) can advantageously be superimposed with the speckle signature of a respective pixel (depending on its state value).

In order to further amplify the speckle reduction, it may be preferred to introduce an additional phase variation for the illumination radiation by the scanning unit and/or by the pixel array.

In a preferred embodiment, the image-generating unit is configured to cause an additional phase variation in the illumination radiation by way of the pixel array and/or the scanning unit.

This allows an increase in the variation of a speckle signature of the pixel array and/or the scanning unit.

Different approaches are conceivable for increasing a variation of a speckle signature of the pixel array and/or of the scanning unit.

In a preferred embodiment, the image-generating unit is configured for an additional modulation of the pixel state per generated image, wherein preferably a modulation frequency of the pixel state is higher than a refresh rate of the image-generating unit by a factor of 2, 4 or more. The expression that the image-generating unit is configured preferably means that a control unit comprised by the image-generating unit is configured to carry out the stated method steps (here: modulation of the pixel state) and, for example, corresponding software and/or firmware is installed for this purpose on the control unit and/or an external data processing apparatus connected thereto.

Similar to amplitude modulation, e.g. for light sources, the state of a single pixel can be changed several times while the eye adds up the images. Preferably, a modulation frequency of the pixel states should be so high that the eye cannot distinguish the individual images. Preferably, a pixel changes its state several times within the desired refresh rate (e.g. 2, 4, 6 or more times). Assuming that the refresh rate or the frequency of the change in state is sufficiently large, the pixel therefore changes its state several times within the integration time of the eye. The state perceived per image preferably corresponds to the average value of all the pixel states within the refresh rate. As an example, this is illustrated in FIG. 3, wherein in the embodiment shown, the state of the pixel changes its state 4 times within the integration time of the eye or within the desired refresh rate (t_int).

In a liquid crystal display, for example, for implementing a modulation frequency of the pixel state, a temporal sequence of different phase values or amplitude values can be specified for a pixel which result in the phase value or amplitude value that is desired for the generated image only when temporally integrated over the refresh rate.

The array frequency corresponds in the preferred embodiment to an integer multiple of the refresh rate, wherein the integer multiple corresponds to a factor of, for example, 2, 4, 6 or more with which the pixel state is changed during the generation of an image point.

The scanning frequency should preferably correspond at least to the modulation frequency of the pixel state or represent an integer multiple of the modulation frequency of the pixel state.

For example, at an array frequency of 120 Hz and a scanning frequency of 120 Hz, the refresh rate can drop to 60 Hz, provided that each pixel assumes two different states per generated image, and for 4 different states the refresh rate drops to 30 Hz.

In a further preferred embodiment, the image-generating unit is configured for an additional modulation of the scanning unit for phase variation of the illumination radiation, wherein preferably a modulation frequency of the scanning unit is higher than a refresh rate of the image-generating unit by a factor of 2, 4, 6 or more and/or wherein preferably one or more components of the scanning unit are excited to vibrations by an actuator.

For the scanning unit, a similar additional effect of speckle reduction can be achieved if different phase values are additionally imprinted on the illumination radiation faster than the eye can resolve.

Preferably, one or more components of the scanning unit can be excited to vibrations by an actuator for this purpose. Preferably, the actuator for this purpose is mechanically coupled to at least one component of the scanning unit and is configured to make the components vibrate. The actuator may, for example, be an electrostatic, piezoelectric, electromagnetic and/or thermal actuator. Preferably, the actuator can also be present as a MEMS actuator and thus be extremely compact. Corresponding actuators, such as piezoelectric or micromechanical modulators, are known in the prior art. For example, oscillating quartzes can also be used as frequency transmitters for an actuator or act themselves as actuators.

In the case of a scanning system comprising one or more scanning mirrors, for example, the mirror surfaces of the scanning mirrors can be excited to vibrations by means of one or more actuators. The vibration excitation by the actuator can take place in the mirror plane (see FIG. 4) and/or perpendicular thereto (see FIG. 5). Likewise, lenses, wedges, prisms or other components of preferred scanning units can be excited to vibrations.

Advantageously, the mechanical vibrations of the components of the scanning unit lead to an additional change or modulation of the speckle signature for a particular scan position (point of incidence of the illumination radiation on the pixel array). In the case of vibration excitation of a scanning mirror or a lens, the surfaces and thus microscopic roughness of the surfaces vibrate at the additional mechanical modulation frequency, so that the speckle pattern or speckle signature on the pixel array changes at that modulation frequency even for a constant scan position.

The additional modulation frequency of the scanning unit may preferably be higher or lower than the scanning frequency of the scanning unit or the array frequency of the pixel array. Preferably, the additional modulation frequency of the scanning unit (e.g. vibration frequency of a component of the scanning unit) should be higher than the refresh rate, preferably by a factor of 2, 4, 6, 8, 10 or more.

In a further preferred embodiment, the image-generating unit additionally comprises one or more diffusers in the beam path between the light source and the light-modulating pixel array, preferably in the beam path between the scanning unit and the light-modulating pixel array.

A diffuser is preferably an optical element which adds an additional randomized or stochastic phase to the illumination beam. Preferably, a diffuser has a multiplicity of randomly distributed scattering centers at which light beams are scattered in different directions.

As illustrated in FIG. 8, a diffuser therefore preferably causes a mixing of individual beams of a possibly collimated illumination radiation which are incident on the diffuser at different points of incidence. As a result, a coherence length of the illumination radiation can be additionally reduced. The diffusers may be designed as optical elements with randomized phase or as one or more lens arrays. Preferably, the diffusers may also be such that their radiation patterns vary depending on the lateral position on the diffuser. This allows the radiation pattern of the overall system to be modified, e.g. to generate a larger or smaller eyebox.

In a preferred embodiment, the diffuser is selected from a group comprising lens array, refractive and/or diffractive diffuser.

The diffuser can cause surface scattering and/or volume scattering. The diffuser may be designed as a reflective or as a transmissive optical element.

In the case of surface scattering, the illumination radiation is preferably scattered at the surface of the diffuser, which surface was preferably treated accordingly for this purpose. For example, a plate made of a transparent material (for example glass) can be mechanically, chemically and/or optically treated to act as a diffuser (cf., inter alia, U.S. Pat. No. 4,035,068 for the provision of a diffusion plate made of glass by grinding and etching a surface). By means of microstructuring the surfaces of transparent materials, a desired diffuser effect can also be specified precisely.

A transmissive diffusion element may preferably also be designed for volume scattering, wherein preferably a substantially transparent material encompasses scattering centers, for example transparent and/or non-transparent particles at which the illumination radiation is phase-modulated and/or amplitude-modulated. In the case of volume scattering, it is preferable to use a thin-layer diffuser, with the result that a reduction of speckle patterns can be achieved as described, but without the performance being greatly reduced.

The diffusion angle is a measure of the scattering power of a diffuser and thus of the mixing of individual beams. In preferred embodiments, the diffusion angle of the one or more diffusers is between 0.5° and 35°, preferably between 1° and 20°, particularly preferably between 1° and 10°.

In a particularly preferred embodiment, the image-generating unit has two or more diffusers, which are preferably arranged successively with a spatial distance in the beam path. The particularly preferred embodiment leads to a further improved reduction of speckle patterns and/or interference patterns.

As shown in FIG. 8, use is advantageously made of the fact that the illumination radiation, which is initially scattered at a first diffuser, at a second diffuser is already incident on the second diffuser at a plurality of different points of incidence. Thereby, a plurality of speckle patterns are superimposed at the same time. The number of the superimposed beams or speckle patterns on the pixel array (as well as in the image plane) is many times higher than it would be with a single diffuser. The arrangement of the diffusers along the optical axis one after the other and with a spatial distance thus leads to a potentiation of the superposition of individual beams. If the spatial frequency of the superimposed speckle patterns is sufficiently high, they cannot be resolved by the eye and thus do not adversely affect the image quality.

In preferred embodiments, the diffusion angle of the first and/or second diffuser is between 0.5° and 35°, preferably 1° and 20°, particularly preferably between 1° and 10°. The spatial distance between the first and the second diffuser is preferably between 0.5 mm and 100 mm, preferably 1 mm to 50 mm.

The image-generating unit can be designed as a display as well as a projector.

In a preferred embodiment, the image-generating unit is formed as a display, wherein the light-modulating pixel array forms a display screen and/or wherein the image generated by the light-modulating pixel array is projected onto a (semi-) transparent display screen. In the preferred embodiment, the image generated by the pixel array can therefore be viewed directly in transmitted light (see FIG. 10), or the image generated by the pixel array is imaged onto a transparent or semi-transparent display screen, which can be viewed in transmitted light.

In a preferred embodiment, the image-generating unit is designed as a projector, wherein the image generated by the light-modulating pixel array is projected onto a reflective, preferably diffusely reflective, projection screen.

In a preferred embodiment, the image-generating unit is used for a head-up display (HUD). HUDs may contain volume-holographic optical units, which are diffractive grating structures that exhibit a strong wavelength dependence (dispersion). As a result, the observation angle of the HUD changes with the wavelength, resulting in an HUD blur in the case of broadband illumination. An image-generating unit for such a HUD should therefore have spectral lines which are as narrow-band as possible. Advantageously, narrow-band, preferably monochromatic illumination radiation can be provided with the aid of the image-generating unit according to the invention, without the associated coherence resulting in adverse interference effects or speckle patterns.

Various possibilities are conceivable for the arrangement of the image-generating unit comprising a scanning unit, light-modulating pixel array and possible other optical components for shaping and/or guiding the illumination radiation.

In a preferred embodiment, the image-generating unit has a substrate body, which is transparent for the illumination radiation, with a coupling surface, via which the illumination radiation within the transparent substrate body is directed to a rear surface on which a redirection element is present, wherein the redirection element is formed in such a way that the incident illumination radiation is redirected toward a front surface of the substrate body through which the illumination radiation exits onto the light-modulating pixel array.

The embodiment has proven to be particularly compact. In particular, the space taken up by the image-generating unit perpendicular to the light-modulating pixel array can be greatly reduced. Preferably, the installation space perpendicular to the pixel array is substantially predetermined by the spacing between the rear and front surfaces of the transparent substrate body, which can preferably be kept extremely small in comparison with the lateral extent of the pixel array (i.e., for example, a height and/or width). In preferred embodiments, the distance between the front and rear surfaces of the transparent substrate body may be smaller than a maximum lateral extent of the pixel array (i.e., a height and/or width, for example) by a factor of 5, 10, 50 or more.

The rear and/or front surface of the transparent substrate body may be formed as planar surfaces. For example, the transparent substrate body can be present in the basic shape as a plane-parallel plate or cuboid. However, it is also possible that the front and/or rear surfaces are curved.

As a basic shape, the transparent substrate body preferably has the shape of a cuboid with a rear and front surface, which are aligned parallel to each other. Preferably, the thickness of the cuboid, i.e. the spacing between the rear and front surface, is significantly smaller than a height and/or width of the rear and/or front surface, which are preferably adapted to the dimensioning of the pixel array. For example, the thickness of the cuboid may be smaller than its height and/or width by a factor of 5, 10, 50 or more. The substrate body is preferably substantially transparent with respect to the wavelength(s) of the illumination radiation.

Preferably, the substrate body comprises a material which is an optical plastic, preferably selected from a group comprising polymethyl methacrylate (PMMA), polycarbonate (PC), cycloolefin polymers (COP), cycloolefin copolymers (COC) and/or an optical glass, preferably selected from the group comprising borosilicate glass, B270, N-BK7, N-SF2, P-SF68, P-SK57Q1, P-SK58A and/or P-BK7.

The image-generating unit is preferably configured to divert the illumination radiation generated by the light source by means of the scanning unit—as described preferably in the form of a beam—onto the coupling surface and to guide it through the substrate body in the direction of the redirection element.

The coupling surface may preferably have a shape which ensures that the illumination radiation experiences as little diversion and/or aberration as possible when entering the transparent substrate body. For example, it may be preferred that the coupling surface has a concave shape, which ensures that the illumination radiation guided by the scanning unit enters the substrate body for different scan positions at a substantially perpendicular angle of incidence relative to the coupling surface (see FIG. 12).

In the transparent material of the substrate body, the illumination radiation is incident on the redirection element, which can preferably be applied directly to a rear surface of the substrate body. The redirection element directs the illumination radiation preferably in the direction of an opposite front surface of the transparent substrate body. The light radiation exits the material through the front surface and is incident on the pixel array.

In preferred embodiments, the redirection element is a redirection hologram, which is preferably formed as a volume hologram, reflective and/or transmissive hologram. The redirection element can preferably also be formed by a microstructured diffractive element and/or by a (structured) mirror surface.

In the case of a diffractive redirection element, for example a redirection hologram, zero-order undiffracted light of the illumination radiation, but also light of the illumination radiation which is diffracted into orders of diffraction other than that desired for the redirection direction, can propagate as interfering light in the transparent substrate body.

For example, while a diffractive redirection element is configured to guide the n-th order illumination radiation in the direction of the pixel array, in that sense the interfering light preferably denotes zero-order undiffracted light of the illumination radiation, but also an order of diffraction different from the n-th order of diffraction.

In a preferred embodiment, the image-generating unit may be configured for interfering light from a diffractive redirection element to be guided at least partially onto the pixel array. Advantageously, light can be guided onto further points of incidence on the pixel array by the interfering light, wherein the additional superposition can cause a further reduction of the visible speckle patterns.

In a preferred embodiment, the image-generating unit may also be configured for interfering light from a diffractive redirection element to leave a surface of the substrate body without being incident on the pixel array. For example, a scanning angle region of the scanning system can be specified for this purpose in such a way that an exit of the interfering light outside the region of the pixel array is ensured. Likewise, it may be preferred that the coupling surface is designed such that the illumination radiation is incident on the redirection element at the same angle of incidence, regardless of the scan position. For this purpose, it may be preferred, for example, to use a free-form optical unit, a biconic lens, rotationally symmetric lens and/or refractive or diffractive elements. Furthermore, the rear surface of the transparent substrate body, on which the redirection element is mounted, can also be adapted—for example with a convex shape—to steer the interfering light away from the pixel array (see FIG. 15).

Preferably, one or more diffusers can also be introduced for the aforementioned compactly designed image-generating units in order to further reduce the visibility of speckle patterns.

The one or more diffusers can preferably lie between the scanning unit and the transparent substrate body, between the transparent substrate body and the pixel array, between the light source and the scanning unit or between the redirection element and the transparent substrate body.

### DETAILED DESCRIPTION

The invention will be explained in more detail below by means of examples and figures, without being limited thereto.

### BRIEF DESCRIPTION OF THE FIGURES

FIG. 1 shows a schematic illustration of a preferred embodiment of an image-generating unit according to the invention.

FIG. 2 shows a schematic illustration of speckle signatures a) of the pixel array and b) of the scanning unit and their superposition for c) a scan position and d) an image point.

FIG. 3 shows a schematic illustration of an increase in the variation of the speckle signature of the pixel array by additional modulation of the pixel state per generated image.

FIGS. 4 and 5 show schematic illustrations of an increase in the variation of the speckle signature of the scanning unit by exciting a scanning mirror to vibrations along the mirror plane (FIG. 4) or perpendicular to the mirror plane (FIG. 5).

FIG. 6 shows a schematic illustration of a preferred embodiment of an image-generating unit with a diffuser in the beam path.

FIG. 7 shows a schematic illustration of a preferred embodiment of an image-generating unit with two diffusers in the beam path.

FIG. 8 shows a schematic illustration of a superposition of a multiplicity of beams by using two diffusers in the beam path.

FIG. 9 shows a schematic illustration of a preferred embodiment of an image-generating unit with a lens to ensure a constant angle of incidence of the illumination radiation on the pixel array.

FIG. 10 shows a schematic illustration of a preferred embodiment of an image-generating unit, which is designed as a display.

FIG. 11 shows a schematic illustration of a preferred embodiment of an image-generating unit, which is designed as a projector.

FIG. 12 shows a schematic illustration of a preferred embodiment of an image-generating unit with a reduced installation space perpendicular to the pixel array.

FIG. 13 shows a schematic illustration of a preferred embodiment of an image-generating unit with a reduced installation space perpendicular to the pixel array, in which interfering light is guided onto the pixel array.

FIGS. 14-16 show schematic illustrations of a preferred embodiment of an image-generating unit with a reduced installation space perpendicular to the pixel array, in which an incidence of interfering light on the pixel array is avoided by specifying the scanning angle (FIG. 14), shaping the redirection element (FIG. 15) or designing the coupling surface (FIG. 16).

### DETAILED DESCRIPTION OF THE FIGURES

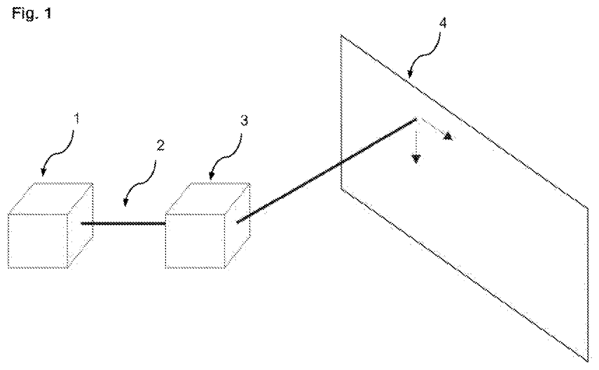

FIG. 1 shows a schematic illustration of a preferred embodiment of an image-generating unit according to the invention.

The image-generating unit comprises at least one light source 1 for generating illumination radiation 2, which is preferably guided as a beam on an optical axis. By means of a scanning unit 3, the illumination radiation 2 is guided over a light-modulating pixel array 4 for generating an image. The light source 1 may be a system of a plurality of, preferably monochromatic lasers, which are steered by further optical components to a common optical axis. The diameter of the beam of the illumination radiation 2, upon incidence on the pixel array 4, may be greater or smaller than the size of a single pixel, but is smaller than the entire pixel array 4.

To reduce speckle patterns, the image-generating unit according to the invention utilizes the fact that both the scanning unit 3 and the light-modulating pixel array 4 have characteristic speckle signatures for different scan positions or pixel states.

Advantageously, the speckle signatures of the scanning unit 3 and the pixel array 4 are superimposed or combined in the scanning process during the generation of an image point, with the result that visible or perceptible speckle patterns in the generated image are reduced.

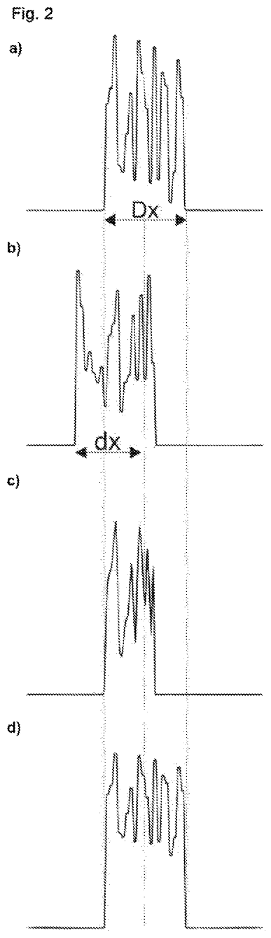

FIG. 2 schematically illustrates the speckle signatures of the pixel array 4 and of the scanning unit 3, as well as their superposition. FIG. 2a) illustrates a speckle signature of a pixel of the light-modulating pixel array 4. The speckle signature of a pixel may depend, for example, on the surface condition and/or the controlled state (e.g. a crystal orientation of an LCD display). Dx denotes the size of the pixel in the scanning direction. FIG. 2b) illustrates a speckle signature of a scanning unit 3 for a specific scan position (dx). In the case of a mirror-based scanning unit 3, the speckle signature may, for example, depend on a surface condition of a mirror surface 5.

In isolation, the speckle signatures of the pixel array (FIG. 2a) or of the scanning unit (FIG. 2b) are characterized by pronounced minima and maxima, which can be perceived by the viewer as differences in brightness or grain in the generated image point or image.

FIG. 2c) illustrates a superimposition of the speckle signature of the scanning unit 3 with that of the pixel array 4 for a specific scan position. This already leads to a higher spatial frequency of the speckle pattern and thus lower visibility. A particularly significant reduction of the speckle patterns is achieved by the fact that when a single pixel is swept over for one and the same image point, a multiplicity of speckle patterns (depending on the scan position) are generated and superimposed with the speckle signature of the pixel.

In a step-by-step scanning process, the number of superimposed speckle patterns is equal to the number of scan steps. In an analog movement, the number of speckle patterns is infinite with a smaller variation between individual speckle patterns. With sufficient scanning frequency, the human eye can no longer distinguish these individual patterns. All speckle patterns that cannot be distinguished by the eye over time are added together. FIG. 2d) illustrates an example of an addition of all the speckle patterns occurring in the −Dx≤dx≤Dx range for a step size of Dx/80. The contrast of the speckle patterns (i.e. the distance between the minima and maxima in the intensity distribution) is clearly reduced such that a significant reduction of perceptible speckle patterns can be achieved.

The inherent variation in speckle signatures of commercially available scanning units and pixel arrays is usually already sufficient for a significant speckle reduction. To further amplify this, an additional phase variation can be introduced through both the scanning unit 3 and the pixel array 4.

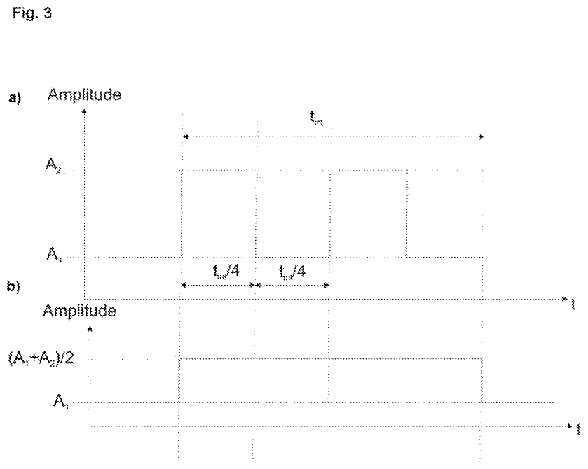

FIG. 3 schematically shows an increase in the variation of the speckle signature of a pixel array 4 by additional modulation of the pixel state per generated image.

Similar to amplitude modulation, e.g. in light sources, the state of a single pixel can be changed several times while the eye adds up the images. To do this, the modulation frequency must be sufficiently high so that the eye cannot distinguish between the individual images.

As shown in FIG. 3a), preferably one pixel can change its state 4 times within the integration time of the eye or within the desired refresh rate (t_int). The perceived state corresponds to the average value of all the states within t_int (see FIG. 3b), wherein corresponding speckle patterns are advantageously superimposed or averaged within the integration time.

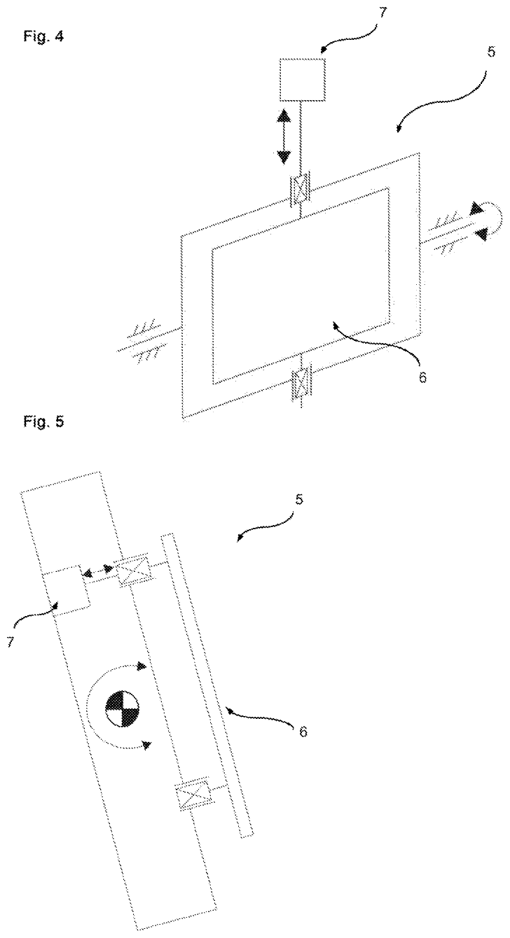

FIGS. 4 and 5 schematically show exemplary embodiments for increasing the variation of the speckle signature of the scanning unit 3 by exciting a scanning mirror 5 to vibrations along the mirror plane 6 (FIG. 4) or perpendicular to the mirror plane 6 (FIG. 5) by means of an actuator 7. The vibration can be caused, for example, by piezoelectric or micromechanical modulators or quartz crystals. Preferably, the speckle signature of the scanning unit 3 is varied by the actuator in a high-frequency manner, wherein the modulation frequency of the scanning unit 3 is preferably significantly higher than the refresh rate.

FIG. 4 shows a scanning mirror 5 with gimbal suspension, which is made to vibrate along the mirror plane 6 by an actuator with frequency transmitter 7. FIG. 5 shows a scanning mirror 5 in gimbal suspension, which is made to vibrate by an actuator with frequency transmitter 7 perpendicular to the mirror plane 6.

In addition, in the beam path, additional elements, which add a speckle signature, can be introduced preferably between the scanning unit 3 and the pixel array 4. Diffusers are preferred, for example, which increase the speckle variance during the scanning process.

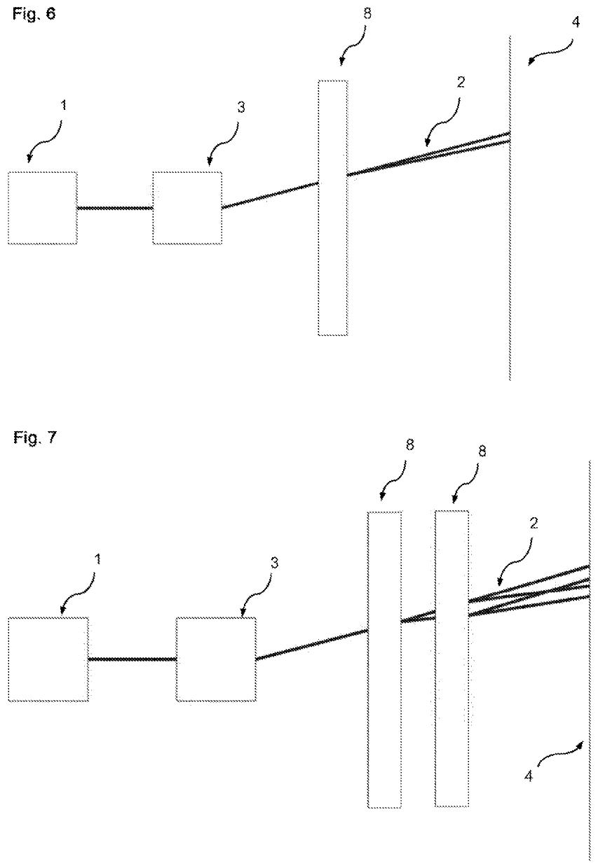

FIG. 6 shows a schematic illustration of a preferred embodiment of an image-generating unit with a diffuser 8 in the beam path. The diffuser 8 may be designed, for example, as an optical element with a randomized phase or as a lens array. The diffuser 8 preferably causes scattering and mixing of individual beams of the illumination radiation 2, which are incident on the diffuser 8 at different points of incidence. Thereby, a coherence length of the illumination radiation 2 is additionally reduced and a visibility of the speckle pattern in the generated image is reduced.

FIG. 7 shows a schematic illustration of a preferred embodiment of an image-generating unit with two diffusers 8 in the beam path. The two diffusers 8 are arranged in the beam path along the propagation direction one after the other with a spatial distance. By means of two diffusers, a further significantly improved reduction of speckle patterns and/or interference patterns can be achieved.

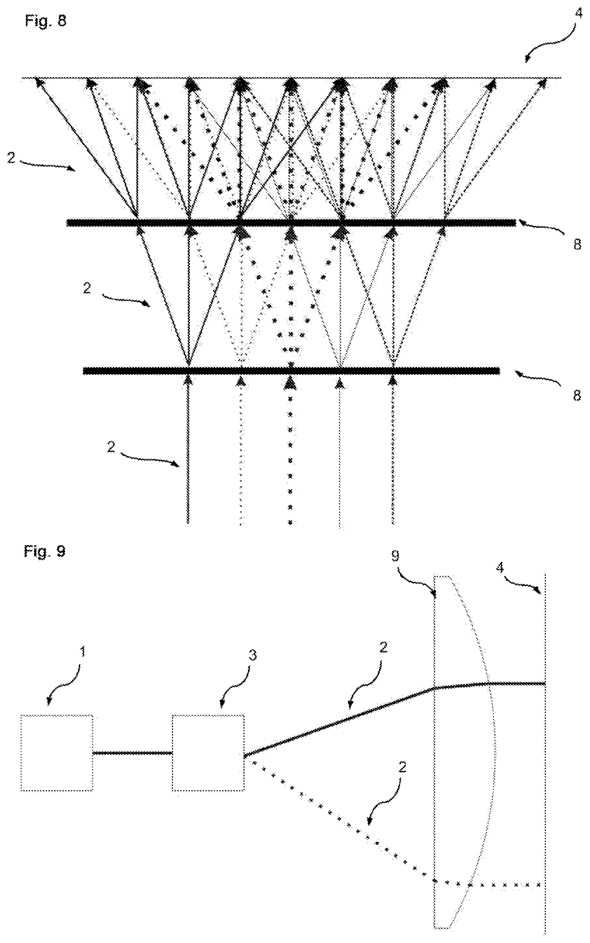

FIG. 8 schematically illustrates the superposition of a multiplicity of beams of the illumination radiation 2 by using two diffusers 8 in the beam path.

The illumination radiation 2, which is scattered at the first diffuser 8, is already incident on the second diffuser 8 at a plurality of different points of incidence, at which further scattering takes place. Thereby, a plurality of speckle patterns are superimposed at the same time. The number of superimposed beams 2 or speckle patterns on the pixel array 4 (as well as in the image plane) is many times higher than it would be with a single diffuser 8.

This is particularly evident when comparing the number of superimposed beams 2 or speckle patterns on the second diffuser 8 and on the pixel array 4. If the spatial frequency of the speckle patterns is high enough, they cannot be resolved by the eye. In addition, radiation beams 2 which are laterally further apart from one another than is the case for a single diffuser 8 are superimposed. This reduces the spatial coherence of the light source. If the coherence length of the light source is sufficiently small, no perceptible speckle patterns are generated. The expansion of the beam 2 is indicated in FIGS. 7 and 8 and preferably corresponds to a diffusion angle.

FIG. 9 shows a schematic illustration of a preferred embodiment of an image-generating unit having a lens 9 to ensure a constant angle of incidence of the illumination radiation 2 on the pixel array 4.

The lens 9 is preferably a refractive, diffractive or Fresnel lens. Preferably, the lens 9—as shown—is positioned between the scanning unit 3 and the pixel array 4 and is configured such that all beams 2 have the same angle of incidence on the pixel array 4 regardless of their spatial position (see FIG. 9 for two exemplary scanning angles and beam profiles). For this purpose, e.g. the scanning unit 3 can be located in the object-side focus of the lens 9. This distance can be varied to modify the radiation pattern of the overall system.

The image-generating unit can be used as a display or as a projector.

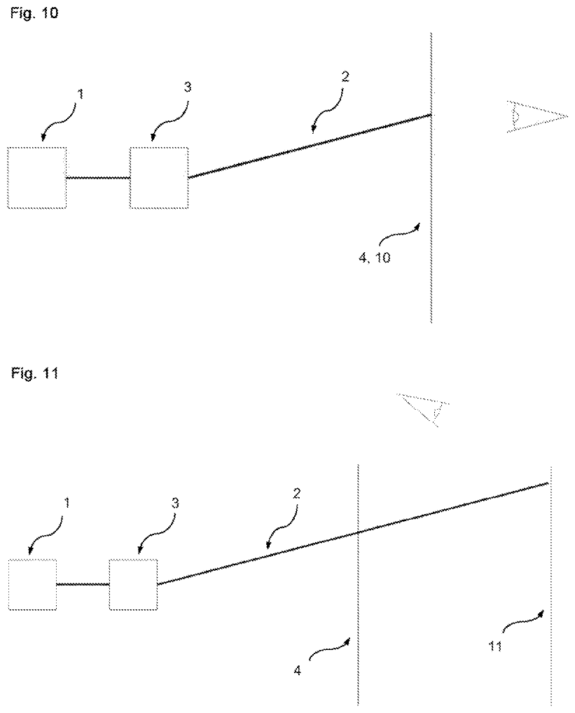

FIG. 10 schematically shows a preferred embodiment of an image-generating unit, which is designed as a display. For use as a display, the pixel array 4 can act as a display screen 10 and be viewed directly (shown), or the pixel array 4 is projected onto a (semi-) transparent display screen 10, which is then viewed in transmitted light (not shown).

FIG. 11 schematically shows a preferred embodiment of an image-generating unit, which is designed as a projector. To be designed as a projector, the pixel array 4 is projected onto a reflective, preferably diffusely reflective, projection screen 11.

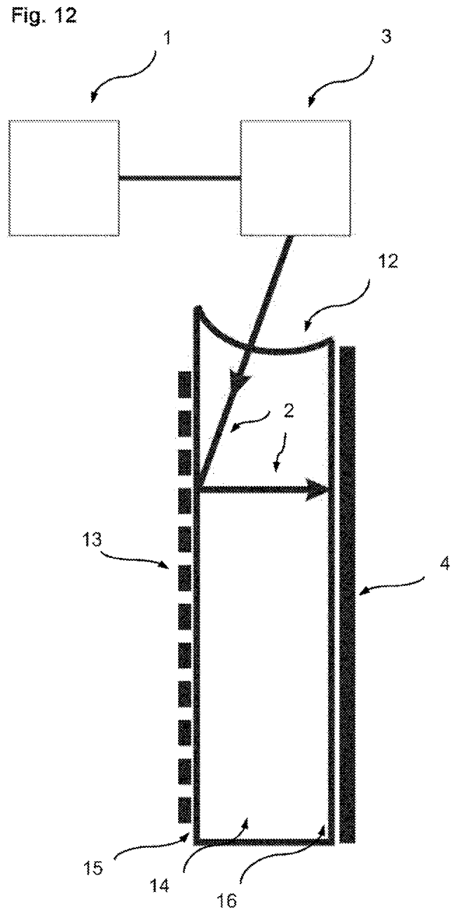

FIG. 12 schematically shows a preferred embodiment of an image-generating unit with a reduced installation space perpendicular to the pixel array 4.

For this purpose, the image-generating unit has a substrate body 14, which is transparent for the illumination radiation 2, with a coupling surface 12, via which the illumination radiation 2 within the transparent substrate body 14 is guided to a rear surface 15, on which a redirection element 13 is present. The redirection element 13 is designed in such a way that the incident illumination radiation 2 is redirected in the direction of a front surface 16 of the substrate body 14, through which the illumination radiation 2 exits onto the light-modulating pixel array 4.

The substrate body 14 is preferably of thin design in relation to the height and width of the pixel array 4 and can have the basic shape of a cuboid, wherein a specially shaped coupling surface 12 is present on at least one surface. To reduce diversions or aberrations, the coupling surface 12 may be concave in such a way that the illumination radiation 2 guided by the scanning unit 3 enters the substrate body 14 at a substantially perpendicular angle of incidence for different scan positions.

The redirection element 13 may be, for example, a volume hologram, a microstructured diffractive element or a (structured) mirror surface. In the case of a diffractive redirection element (e.g. volume hologram), zero-order undiffracted light, but also light which is diffracted into diffraction orders other than the desired one, can propagate as interfering light 17 in the transparent substrate body 14.

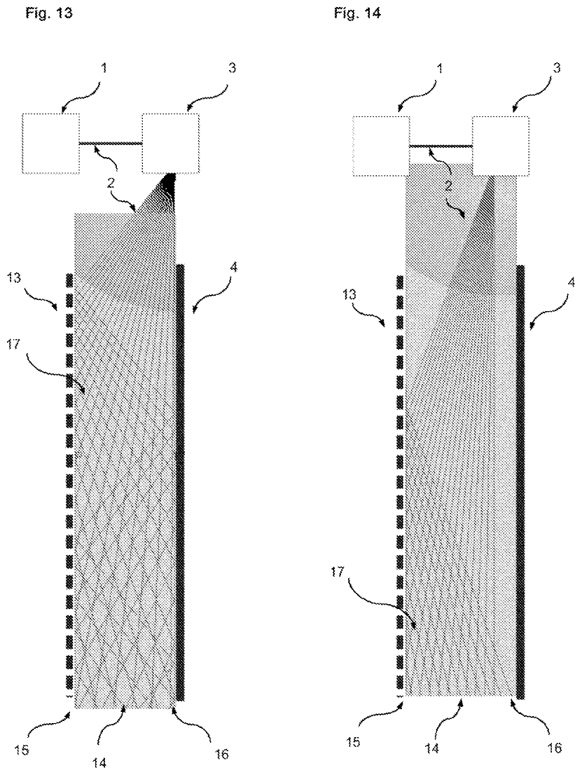

FIG. 13 schematically shows a preferred embodiment of an image-generating unit in which the interfering light 17 is at least partially guided onto the pixel array 4.

This allows light to be steered to a plurality of points on the pixel array 4 simultaneously in order to further reduce visible speckles in this way.

FIGS. 14-16 show schematic illustrations of preferred embodiments of image-generating units according to the invention, in which an incidence of interfering light 17 on the pixel array 17 is avoided.

In FIG. 14, the scanning angle of the scanning unit 3 is specified such that the interfering light 17 does not exit from the front surface 16 onto the pixel array 4, but from a lower surface of the substrate body 14.

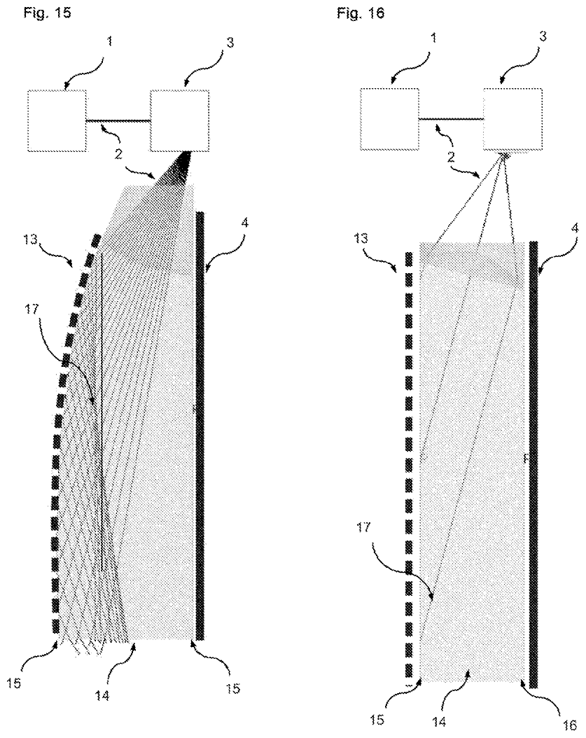

In FIG. 15, the rear surface 15 of the transparent substrate body 14 on which the redirection element 13 is mounted is adapted in such a way that the interfering light 17 is steered away from the pixel array 4.

In FIG. 16, the coupling surface 12 is designed such that all beams of the illumination radiation 2 from the scanning unit 3 are incident on the redirection element 13 at the same angle. For example, a free-form optical unit, a biconic lens or a rotationally symmetric lens can be used for this purpose.

It is noted that various alternatives to the embodiments of the invention described can be used to carry out the invention and to arrive at the solution according to the invention. The image-generating unit according to the invention is therefore not limited in its embodiments to the above preferred embodiments. Rather, a large number of design variants which can deviate from the solution shown are conceivable. The aim of the claims is to define the scope of protection of the invention. The scope of protection of the claims is aimed at covering the image-generating unit according to the invention and equivalent embodiments thereof.

### LIST OF REFERENCE SIGNS

1 Light source
2 Illumination radiation
3 Scanning unit
4 Light-modulating pixel array
5 Scanning mirror
6 Mirror plane
7 Actuator
8 Diffuser
9 Lens
10 Display screen
11 Projection screen
12 Coupling surface
13 Redirection element
14 Transparent substrate body
15 Rear surface of the substrate body
16 Front surface of the substrate body
17 Interfering light

1. An image generator comprising:
a light source for generating illumination radiation;
a scanner configured to scan said illumination radiation; and
a light-modulating pixel array for generating an image by pixel-wise modulation of the illumination radiation incident on the pixel array, wherein the illumination radiation, upon incidence on the light-modulating pixel array, has a lateral extent that is smaller than the pixel array and is guided over the pixel array to generate an image using said scanner to reduce visibility of speckle patterns in the generated image.

2. The image-generator according to claim 1,
wherein the illumination radiation comprises coherent radiation and/or the light source comprises a laser.

3. The image-generator according to claim 1,
wherein the image-generator comprises two or more light sources.

4. The image-generator according to claim 1,
wherein the scanner comprises one or more scanning mirrors, lenses, prisms, wedges, diffractive optical elements (DOEs) or a combination of any of these.

5. The image-generator according to claim 1,
wherein the light-modulating pixel array is selected from the group comprising a spatial light modulator (SLM), a liquid crystal display (LCD), a micromirror array or a combination of any of these.

6. The image-generator according to claim 1,
wherein the illumination radiation, upon incidence on the pixel array, has a lateral extent which is smaller than the pixel array by a factor of 5 or more and/or wherein the illumination radiation, upon incidence on the pixel array (4), has a lateral extent of less than 50 pixels or less.

7. The image-generator according to claim 1,
wherein a scanning frequency of the scanner and/or an array frequency of the pixel array is at least 20 Hz.

8. The image-generator according to claim 1,
wherein for increasing a variation of a speckle signature of the pixel array and/or of the scanner, the image generator is configured to effect an additional phase variation of the illumination radiation by the pixel array and/or by the scanner.

9. The image-generator according to claim 1,
wherein for increasing a variation of a speckle signature of the pixel array, the image generator is configured for an additional modulation of the pixel state per generated image.

10. The image-generator according to claim 1,
wherein for increasing a variation of the speckle signature of the scanner, the image generator is configured for an additional modulation of the scanner for phase variation of the illumination radiation.

11. The image-generator according to claim 1,
wherein the image generator additionally comprises one or more diffusers in a beam path between the light source and the light-modulating pixel array.

12. The image-generator according to claim 1,
wherein the image generator comprises two or more diffusers, that are arranged successively at a spatial distance in the beam path.

13. The image-generator according to claim 1,
wherein the image generator comprises a display, wherein the light-modulating pixel array forms a display screen and/or wherein the image generated by the light-modulating pixel array is projected onto a (semi-) transparent display screen.

14. The image-generator according to claim 1,
wherein the image generator comprises a projector, wherein the light-modulating pixel array is projected onto a reflective projection screen.

15. The image-generator according to claim 1,
wherein the image generator further comprises a substrate body that is transparent to the illumination radiation, with a coupling surface through which the illumination radiation within the transparent substrate body is guided to a rear surface having thereon a redirection element, wherein the redirection element is configured such that the incident illumination radiation is redirected in the direction toward a front surface of the substrate body through which the illumination radiation exits onto the light-modulating pixel array.

16. The image-generator according to claim 3, wherein the image generator comprises two or more monochromatic lasers.

17. The image-generator according to claim 9, wherein a modulation frequency of the pixel state is higher than a refresh rate of the image generator by a factor of 2 or more.

18. The image-generator according to claim 10, wherein a modulation frequency of the scanner is higher than a refresh rate of the image generator by a factor of 2, 4, or 6.

19. The image-generator according to claim 10, wherein one or more components of the scanner are caused to vibrate using an actuator.

20. The image-generator according to claim 11, wherein the one or more diffusers are positioned in a beam path between the scanner and the light-modulating pixel array.
